(19) United States
(12) Patent Application Publication
(10) Pub. No.: US 2006/0152580 A1
(43) Pub. Date: Jul. 13, 2006

(54) Auto-stereoscopic volumetric imaging system and method

(75) Inventor: Robert Edward Andrews, Grosse Ile, MI (US)

Correspondence Address: SYNNESTVEDT LECHNER & WOODBRIDGE LLP, P O BOX 592, PRINCETON, NJ, 08542-0592, US

(73) Assignee: Synthosys, LLC, Camden, NJ (US)

(21) Appl. No.: 11/286,224

(22) Filed: Nov. 23, 2005

Related U.S. Application Data
(60) Provisional application No. 60/641,947, filed on Jan. 7, 2005.

(51) Int. Cl. H04N 13/04; H04N 15/00; H04N 9/47

(52) U.S. Cl. 348/60

(57) ABSTRACT

A system for auto-stereoscopic presentation of stereo-image pairs that uses volumetric imaging elements so that a viewer may experience a 3-D illusion that appears to be located in a space free of system components. A reflecting optical element produces a real image of part of the auto-stereoscopic imaging system, in a position that is indicative of where a viewer must place their eyes in order to see the 2-D stereo images so that stereopsis may occur, and a 3-D image perceived. A viewer can clearly see where to place there eyes, and without any actual physical elements of the imaging system in, or around, the region where the 3-D image is perceived to be, allowing the viewer to touch the images being observed. Furthermore, in such a system, real objects may be located along side the 3-D images, further enhancing the stereoscopic 3-D illusion by providing additional depth cues.

### CROSS REFERENCE TO RELATED APPLICATIONS

This application is related to, and claims priority from, U.S. Provisional Patent application No. 60/641,947 filed on Jan. 7, 2005, by Robert E. Andrews entitled “Auto-Stereoscopic Volumetric Imaging System”, the contents of which are hereby incorporated by reference.

### FIELD OF THE INVENTION

The present invention relates to auto-stereoscopic imaging systems and methods, and more particularly to auto-stereoscopic imaging systems and methods that employ volumetric imaging components.

### BACKGROUND OF THE INVENTION

The present invention provides a system and method for auto-stereoscopic presentation of images.

Stereoscopy is a well-known process in which a viewer perceives a three-dimension (3D) object when shown a stereo pair of two-dimensional (2-D) images of the object. In particular, when a viewer is presented with one 2-D image corresponding to a left eye view of the object and another 2-D image corresponding to a right eye view of the same object, the viewer's brain merges the images to produce a 3-D perception of the scene. This phenomena is sometimes called stereopsis and is part of the mental process in visual perception by which an observer discerns the depth or distance of objects from the observer.

Generally, stereoscopy may be accomplished one of three general methods in which each eye receives image information of the same subject from two slightly different viewpoints.

In a first general method for stereoscopy, a single 2-D image, or anaglyph, contains all the information for both 2-D stereo views. The left and the right stereo images, however, are encoded with some optically separable quality, and the viewer wears glasses that ensure that each eye receives only the correct view. For instance, in viewing simple color anaglyph images, in which the left and right eye stereo pairs are encoded as different colors, the viewer wears glasses with color filters that ensure that each eye only sees one of the stereo pairs. Similarly, to view polarized anaglyphs, in which the left and right eye images are encoded in orthogonal polarizations, glasses with appropriate polarization filters are used to separate the images and ensure that each eye only sees one of the stereo pairs.

In the second general method for stereoscopy, a single screen presents the 2-D stereo pairs sequentially in time. The viewer wears glasses that have shutters synchronized to the presentation of the images, so that each eye only sees the appropriate stereo image.

Stereoscopic systems based on both these first two methods have two major drawbacks. Firstly, the viewer has to wear special stereo glasses. Secondly, each eye only sees an image that has half the maximum intensity the display screen is capable of providing.

A third general method of presenting stereo images is by use of auto-stereoscopic imaging systems. These are optical projection systems that display both of the stereo 2-D images simultaneously, either on separate displays, or on separate parts of a single display. An optical system relays each image such that, when a viewer places their eyes at certain predetermined locations, each eye only sees one of the stereo pairs, and stereopsis occurs. Head mounted displays, such as the early Virtual Reality (VR) helmets in which two small display monitors, about an inch wide, were place in front of each eye are an example of an auto-stereoscopic imaging system.

Auto-stereoscopic viewing systems have the advantage of not requiring the viewer to wear special glasses. Furthermore, an auto-stereoscopic system in which a separated screen displays each image, allows each eye to see an image at the full screen brightness so that the 3-D image is perceived to be twice as bright as an image on a single screen.

Auto-stereoscopic stereo image viewing systems, however, do have the disadvantage that the viewer's eyes have to be located at particular locations in space. This may require the use of additional, cumbersome equipment as in the example of the VR viewing helmet.

A further drawback of typical implementations of all these general methods of presenting stereo images is that the 3-D object appears to be located in the same space as some the optical elements used to create the illusion. This collocation of the stereoscope components and the illusion prevents the viewer from attempting to touch the object of the illusion.

### SUMMARY OF THE INVENTION

Briefly described, the present invention provides a system, apparatus and method for auto-stereoscopic presentation of stereo-image pairs that uses volumetric imaging elements and processes so that a viewer may experience a 3-D illusion that appears to be located in a space free of system components.

In a preferred embodiment, the auto-stereoscopic stereo, volumetric imaging system (also known as a volumetric imager) includes a large format reflecting optical element that produces a real image of a reflecting prism and a relay lens that are part of the auto-stereoscopic volumetric imaging system. The real images of the prism and relay lens are projected to positions that are indicative of where a viewer must place their eyes in order to see the 2-D stereo images so that stereopsis may occur, and a 3-D image may be perceived. To a viewer using the system, the stereo image pairs that are observed auto-stereoscopically, for instance, may appear to be on the real image of the reflecting prism.

One advantage of such a system is that the viewer can clearly see where to place their eyes, and yet there are no actual physical elements of the auto stereoscopic, volumetric imaging system in, or around, the region where the 3-D image is perceived to be. This allows 3-D viewing in which the viewer may attempt to touch the images being observed. Furthermore, in such a system, real objects may be located along side the 3-D images, further enhancing the stereoscopic 3-D illusion by providing additional depth cues.

In a preferred embodiment of the invention the large format optical element is a section of a sphere, whose concave reflective surface has an arc length greater than ¾ of a meter and whose radius of curvature is larger than 1 meter.

These and other features of the invention will be more fully understood by references to the following drawings.

### BRIEF DESCRIPTION OF THE DRAWINGS

FIG. 1 is an isometric drawing showing a schematic representation of an auto-stereoscopic volumetric imaging system in accordance with one embodiment of the present invention.

FIG. 2 is a drawing showing a plan view of a schematic representation of an auto-stereoscopic volumetric imaging system in accordance with one embodiment of the present invention.

FIG. 3 is a drawing showing a plan view of the principal optical elements of an auto-stereoscopic imaging system in accordance with one embodiment of the present invention.

FIG. 4A is a drawing showing a pseudo-sagittal view of one-half of the principal stereoscopic optical elements of an auto-stereoscopic, volumetric imaging system in accordance with one embodiment of the present invention.

FIG. 4B is a drawing showing a sagittal view of the principal optical elements for creating a locating real image of an auto-stereoscopic, volumetric imaging system in accordance with one embodiment of the present invention.

FIG. 5 is a drawing showing a pseudo-sagittal view of the principal optical elements of an auto-stereoscopic, volumetric imaging system in accordance with one embodiment of the present invention.

### DETAILED DESCRIPTION

The present invention relates to a method, system and apparatus for auto-stereoscopic volumetric imaging. In a preferred embodiment, the invention incorporates volumetric viewing elements so that a viewer may have a virtual object to guide the viewer as to where to place their eyes in order to perceive the 3-D illusion. In addition, the volumetric imaging elements allow the perceived location of the 3-D illusion to be in a space that does not contain any elements of the auto-stereoscopic system. This allows volumetric imaging in which other real objects may be co-located with the perceived three-dimensional object, heightening the illusion by adding real depth cues. This auto-stereoscopic, volumetric imaging arrangement also allows a user to interact virtually with the perceived three-dimensional object by observing their hands or fingers attempt to touch, feel or hold the virtual object or its surface.

A preferred embodiment of the present invention will now be described in greater detail by reference to the accompanying drawings in which, as far as possible, like numbers represent like elements.

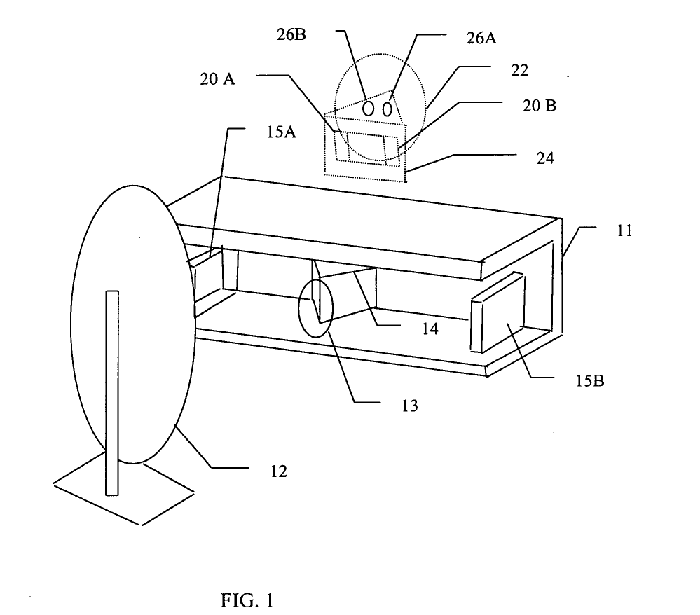

FIG. 1 is an isometric drawing showing a schematic representation of an auto-stereoscopic, volumetric imaging system in accordance with one embodiment of the present invention. The system includes an optical cabinet 11, a digital fusion module having a reflecting prism 14, a left-eye image display 15A, a right-eye image display 15B and a relay lens 13; and an image delivery system having a large format reflecting optical element 12. The relay lens 13 is preferably an achromatic lens such as, but not limited to, a doublet achromatic lens.

The image delivery system produces a real prism image 24 of the prism 14, primarily by means of the reflection imaging properties of the large format optical element 12. The large format optical element may be, but is not limited to, a concave reflecting element such as a mirror having a concave reflecting surface that is spherical or part of an oblate spheroid. In one preferred embodiment, the large format optical element 12 is an aluminized, front surface mirror having a diameter of 760 mm and a focal length of 1350 mm. For good imaging performance, the front, optical reflecting surface of the large format optical element 12 preferably has ½ wavelength surface smoothness at 560 nm.

The focal properties, position and alignment of the relay lens 13, the prism 14 and the image displays 15A and 15B may be selected so that a left display-image 20A and a right display-image 20B over-lap in space, in the approximate region of the rear of the real prism image 24. In a preferred embodiment of the invention, the left and right display images 20A and 20B are real images. The degree of overlap of the relayed, real images 20A and 2B may be varied from completely where they completely overlap each other and are effectively collocated in space, to any suitable degree of horizontal separation that approximately matches the eye separation of the user. A the normal, adult eye separation is about 62 mm, a separation capability in the range from about 10 mm to about 80 should cover most potential users of the system.

These left and right display-images 20A and 20B may be viewed by a human eye having the pupil located within the optimal viewing regions 26A and 26B, which may be arranged to coincide with some part of the real image of the prism. A pupil placed within optimal viewing region 26A will, however, only see the left-image 20 A of image display 15A. Similarly, a pupil placed within optimal viewing region 26B will, however, only see the right-image 20B of image display 15B.

In a further embodiment of the invention, the left and right display-images 20A and 20B may not be co-planer but one may be displaced further from the viewer eyes than then the other so as to accommodate for a viewer having different focusing capabilities in each of their eyes. The variation in the location of the left and right display-images 20 A and 20 B may be accomplished, for instance, by varying the location or the angle of the reflecting surfaces of the prism 14, or the positions of the image displays 15 A or 15 B relative to the reflecting surfaces, or some combination thereof.

In addition, the focal properties, position and alignment of the optical elements may be selected so that the optimal viewing region 26A and 26B are separated by approximately the average distance between pupils in an adult human. As a result, if image displays 15A and 15B simultaneously display corresponding stereo images, an adult human with their pupils located within the optimal viewing regions may experience stereopsis, and may experience the illusion of seeing a virtual three-dimension object.

Because the optimal viewing regions 26A and 26B are collocated with a part of the real prism image 24, a person has a clear indication of where to place their eyes in order to use the auto-stereoscopic viewing system of this invention, without there being any physical parts of the viewing system in the vicinity of the perceived three-dimensional objects seen by that person.

One of ordinary skill in the art will appreciate that the method and system of this invention is not limited to having the front surfaces of the real prism image 24 collocated with the optimal viewing regions 26A and 26B, but that as long as any identifiable portion of the real image of an object is located a predetermined distance from at least one of optimal viewing regions, the system may function. For instance, the system may be arranged so that by placing one's nose at the apex of the real prism image, one's eyes would be correctly located to view the images so as to produce stereopsis.

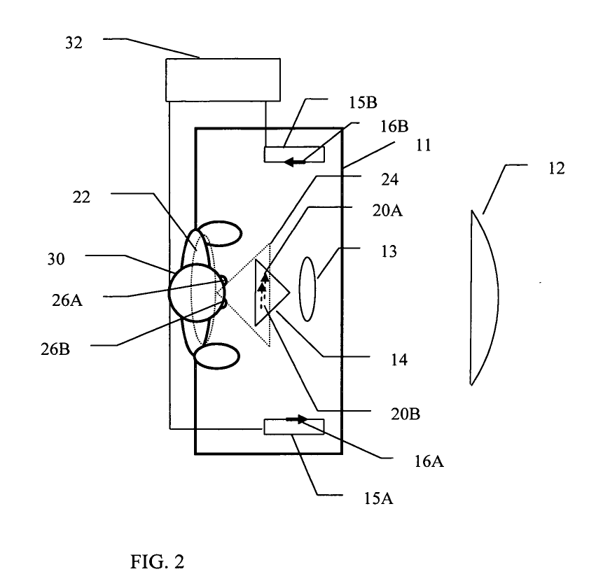

FIG. 2 is a drawing showing a plan view of a schematic representation of an auto-stereoscopic imaging system in accordance with one embodiment of the present invention. In FIG. 2, the schematic is drawn as though the upper surface of optical cabinet 11 is transparent so as to simplify the representation of the images displays 15A and 15B, the reflecting prism 14 and the transfer lens 13. One of ordinary skill in the art will readily appreciate that although the optical cabinet may have a transparent glass top, in a preferred embodiment the upper surface may be an opaque surface.

FIG. 2 shows a user 30 placing their face effectively touching the real prism image 24 so that their eyes are collocated at the optimal viewing locations 26A and 26B.

Optimal viewing location 26A is a location in space from where a viewer, looking in the required direction, will see an image 20A of the object 16A that is being displayed on display screen 15A. The image 20A, which is preferably a real image, is formed by the combined imaging properties of a facet of reflecting prism 14, the transfer lens 13 and the large format reflecting optical element 12.

Similarly, optimal viewing location 26B is a location in space from where a viewer, looking in the required direction, will see an image 20B of the object 16A that is being displayed on of display screen 15B, as imaged by one facet of the reflecting prism 14, the transfer lens 13 and the large format reflecting optical element 12.

As the optimal viewing locations 26A and 26B are separated by approximately the same separation as an average viewers eyes, an average viewer positioned as shown in FIG. 2, will see only the relayed image 20A of the image displayed on display screen 15A with their left eye, and only the relayed image 20B displayed on display screen 15B with their right eye. Both relayed images 20A and 20B may, however, appear to be collocated, or to be separated by a horizontal displacement relative to each other so that stereopsis occurs when a user views them.

An image server 32 is a device capable of storing and distributing images. The images server may be, but not limited to, a personal computer having appropriate storage devices and running appropriate software.

If the image server 32 delivers appropriately matched stereo images to image displays 15A and 15B, a viewer with their eyes located at optimal viewing regions 26A and 26B may experience stereopsis. This may occur although the relayed images 20A and 20B are horizontally displaced relative to each other because each relayed image is only seen with one eye. The user's brain effectively collocates the images with the result that the user experiences the illusion of seeing a virtual three dimensional image.

The stereo images delivered by image server 32 may be still images, or they may be a sequence of images in the form of a video or any combination thereof. Video images may include the external surfaces of objects as in the case of video camera feeds or the interior structures in the case of penetrating imaging such as, for example, x-ray, MRI, PET or other such imaging technologies. One of ordinary skill in the art will realize that the stereo image pairs may be produced or manipulated by any suitable image production or manipulation means including, but not limited to any suitable digital or analogue computer enhancement, manipulation, processing or generation method.

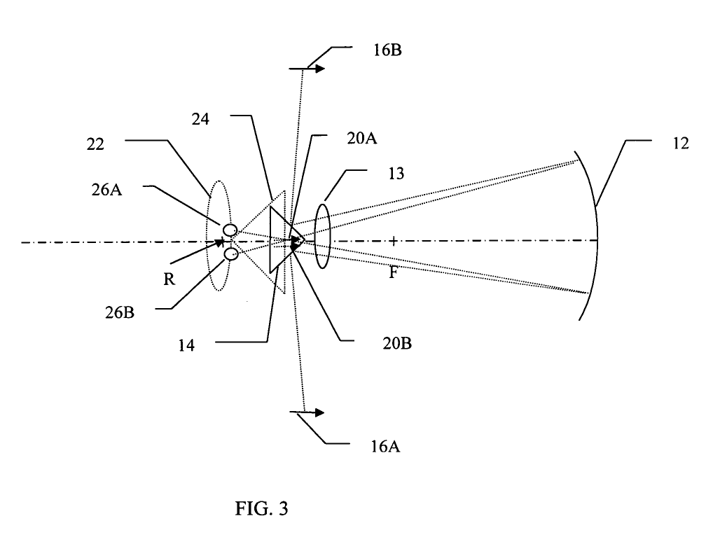

FIG. 3 is a drawing showing a plan view of the principal optical elements of an auto-stereoscopic imaging system in accordance with one embodiment of the present invention.

Large format reflecting optical element 12, which may have an inner reflecting surface that is part of a sphere or an oblate spheroid, is shown as having a principle radius of curvature R, centered at location R. Such a surface has a focal point F such that F is half of R.

Object 16A is the surface of the display screen 15A (not shown in FIG. 3). Object 16A is imaged as image 20A by a reflection off one facet of reflecting prism 14 and the combined imaging properties of transfer lens 13 and the large format reflecting optical element 12. The image 20A is best viewed by a human observer having the pupil of an eye located within the optimal viewing location 26A.

Similarly, object 16B is the surface of the display screen 15B (not shown in FIG. 3). Object 16B is imaged as image 20B by a reflection off one facet of reflecting prism 14 and the combined imaging properties of transfer lens 13 and the large format reflecting optical element 12. The image 20B is best viewed by a human observer having the pupil of an eye located within the optimal viewing location 26B.

It is well-known that an object placed at the center of curvature of a spherical mirror will produce a real image, also at the center of curvature and having unit magnification. Similarly, it is well known that placing an object between the center of curvature and the focal point of a spherical mirror will result in a real image located a corresponding distance beyond the radius of curvature and having a corresponding magnification.

By careful selection of the principal radius of curvature of the large format reflecting optical element 12, the focal length and position of the transfer lens 13, the position of the reflecting prism 14 and the position of the display images 16A and 16B on the display screens 15A and 15B, the optimal viewing locations 26A and 26B can be collocated with part of the real image of the prism 24.

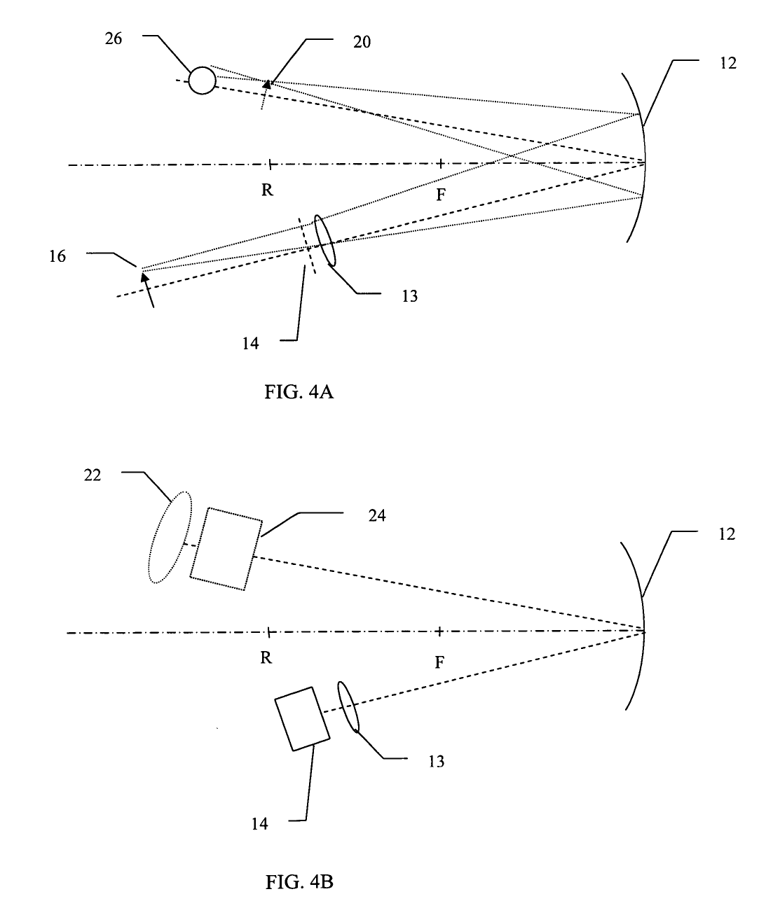

FIG. 4A is a drawing showing a pseudo-sagittal view of the principal stereoscopic optical elements of an auto-stereoscopic, volumetric imaging system in accordance with one embodiment of the present invention.

The effect of reflecting prism 14 is represented unfolded, i.e., the line joining prism surface 14 to objects 16 A& B would, in reality, be normal to the page but is shown here folded back onto the page, hence the view is only a pseudo-sagittal representation.

One objective of showing the pseudo-sagittal view of FIG. 4A is to show how the display images 16A and 16B are projected from beneath the normal to the large format reflecting element 12, represented by the line joining R and F, to above it, as images 20A and 20B, which are best viewed by a pupil place at optimal viewing regions 26A and 26B. In this way, the images 20A and 20B may be located above the optical cabinet (not shown in FIG. 4), in a region free of any components of the auto-stereoscopic imaging system. The images 20A and 20B may be collocated in space or they may have some degree of lateral or horizontal separation or displacement relative to each other. This horizontal displacement allows a user to view the images in a more relaxed manner and achieve stereopsis.

FIG. 4B is a drawing showing a sagittal view of the principal optical elements for creating a locating real image of an auto-stereoscopic, volumetric imaging system in accordance with one embodiment of the present invention.

One objective of showing the view of 4B is to illustrate how real images of the transfer lens 13 and the reflecting prism 14 are produced by the large format reflecting element 12. In particular, by placing the transfer lens 13 and the reflecting prism 14 beneath the normal to the large format reflecting element 12 and between the radius of curvature R and the focal point F, an enlarged, real prism image 24, and an enlarged, real transfer lens image 22 are produced above the normal, R-F, of the large format reflecting element 12.

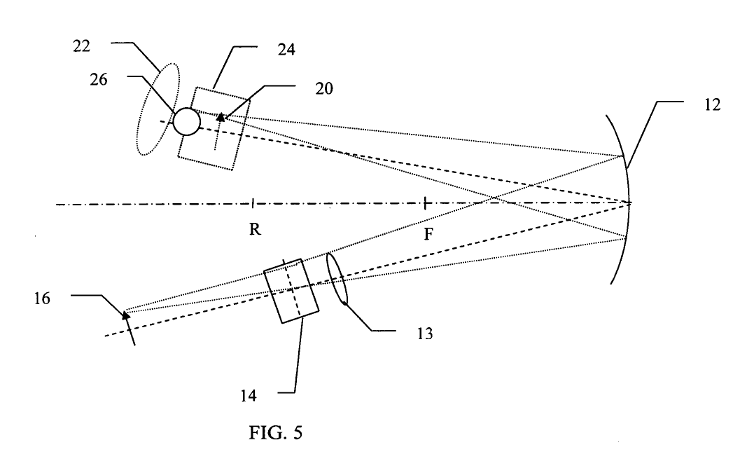

FIG. 5 is a drawing showing a view of all the principal optical elements of an auto-stereoscopic, volumetric imaging system in accordance with one embodiment of the present invention. FIG. 5 is essentially a combination of FIGS. 4A and 4B, and illustrates the collocation of the regions of optimal viewing 26A and 26B with the front surfaces of the real prism image 24.

In further embodiments of the invention, the large format reflecting optical element 12 may be a spherical mirror and may have a radius of curvature greater than 1 meter or larger. In many applications, the radius of curvature of the large format reflecting optical element 12 may be greater than 2 meters and may even exceed 3 or 4 meters.

In a further embodiment of the invention, the relay optic 13 may consist of two separate achromatic, optical refracting elements, each being used to relay either the image from the left-eye image display 15A or the right-eye image display 15B.

In another embodiment of the invention, the angle between the reflecting surfaces of the prism 14 may be varied to effect horizontal displacement of the images 20A and 20B relative to each other. The reflecting surfaces, for instance, may be two independent flat mirrors capable of independent angular adjustment with respect to each other.

In a further embodiment of the invention the positions of the image displays 15A and 15 B relative to the reflecting surfaces of the prism 14 may be variable so that the relative position of the images 20A and 20B relative to the optimal viewing locations 26A and 26B may be varied.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

What is claimed is:

1. A method of volumetric imaging, comprising the steps of:
providing an auto-stereoscopic display system having a left eye optimal viewing region and a right eye optimal viewing region, said left eye viewing region being indicative of a location of a pupil in order to view a first stereo image intended for a left eye, and said right eye viewing region being indicative of a location of a pupil in order to view a second stereo image intended for a right eye;
providing a real image of an object; and
locating at least one identifiable portion of said real image of said object at a predetermined distance from at least one of said optimal viewing regions.

2. The method of claim 1 wherein said locating step further comprises locating said one of said identifiable portions of said real image of said object at one of either said left or said right eye optimal viewing region.

3. The method of claim 2 wherein said object is a reflecting prism and wherein said providing a real image step comprises positioning a concave reflecting element having a principal radius of curvature such that said reflecting prism is located between a center of curvature and a focal point of said concave reflecting element.

4. The method of claim 3 wherein said concave reflecting element is a spherical mirror having a radius of curvature greater than about 1 m.

5. The method of claim 3 wherein said concave reflecting element is an oblate spheroid mirror having a principal radius of curvature greater than about 1 m.

6. The method of claim 1 wherein said first and second stereo images are real images located substantially in the same plane and have a horizontal displacement relative to each other, said horizontal displacement being in the range of about 10 mm to about 80 mm.

7. The method of claim 6 wherein said horizontal displacement is about 62 mm.

8. The method of claim 1 wherein said first and second stereo images are real images located substantially in the same plane and are substantially co-located.

9. A method of volumetric imaging, comprising the steps of:
providing an auto-stereoscopic display system having a left eye optimal viewing region and a right eye optimal viewing region, said left eye viewing region being indicative of a location of a pupil in order to view a first stereo image intended for a left eye, and said right eye viewing region being indicative of a location of a pupil in order to view a second stereo image intended for a right eye, said auto stereoscopic display system comprising a spherical mirror having a center of curvature and a focal point, a relay lens, a reflective prism, and a left and a right video display;
placing said prism between said center of curvature and said focal point, thereby creating a real image of said prism at a location beyond said center of curvature; and
arranging said relay lens such that the combination of said relay lens, said prism and said spherical mirror such that an identifiable portion of said real image of said object is located at one of either said left or said right eye optimal viewing region.

10. A system for volumetric imaging, comprising:
an auto stereoscopic display having a left eye optimal viewing region and a right eye optimal viewing region, said left eye viewing region being indicative of a location of a pupil in order to view a first stereo image intended for a left eye, and said right eye viewing region being indicative of a location of a pupil in order to view a second stereo image intended for a right eye; and
a real image of an object located such that at least one identifiable portion of said real image of said object has a predetermined separation from at least one of said optimal viewing regions.

11. The system of claim 10 wherein said at least one identifiable portion of said real image of said object is located at one of either said left or said right eye optimal viewing region.

12. The system of claim 11 wherein said object is a reflecting prism and wherein said real image is provided by positioning a concave reflecting element having a principal radius of curvature such that said reflecting prism is located between a center of curvature and a focal point of said concave reflecting element.

13. The method of claim 12 wherein said concave reflecting element is a spherical mirror having a radius of curvature greater than about 1 m.

14. The method of claim 12 wherein said concave reflecting element is an oblate spheroid mirror having a principal radius of curvature greater than about 1 m.

15. The system of claim 10 wherein said first and second stereo images are real images located substantially in the same plane and have a horizontal displacement relative to each other, said horizontal displacement being in the range of about 10 mm to about 80 mm.

16. The system of claim 15 wherein said horizontal displacement is about 62 mm.

17. The system of claim 10 wherein said first and second stereo images are real images located substantially in the same plane and are substantially co-located.

18. A volumetric imager, comprising:
an auto-stereoscopic display system having a left eye optimal viewing region and a right eye optimal viewing region, said left eye viewing region being indicative of a location of a pupil in order to view a first stereo image intended for a left eye, and said right eye viewing region being indicative of a location of a pupil in order to view a second stereo image intended for a right eye, said auto stereoscopic display system comprising a spherical mirror having a center of curvature and a focal point, a relay lens, a reflective prism, and a left and a right video display, and wherein said first and second stereo images are real images located in substantially the same plane and have a horizontal displacement relative to each other, said horizontal displacement being in the range of about 10 mm to about 80 mm;
a real image of said prism at a location beyond said center of curvature, created by placing said prism between said center of curvature and said focal point; and
an identifiable portion of said real image of said object located at each of said left and right eye optimal viewing regions by imaging properties of the combination of said relay lens, said prism and said spherical mirror;
